(19) United States
(12) Patent Application Publication
(10) Pub. No.: US 2022/0322646 A1
(43) Pub. Date: Oct. 13, 2022

(54) SYSTEM FOR CLEANING WALLS OF AQUATIC BASINS WITH MOTORIZED TRAVELLER

(71) Applicant: ABYSSNAUT, Olliergues (FR)

(72) Inventor: Jerome BERENGUER, Olliergues (FR)

(21) Appl. No.: 17/616,944

(22) PCT Filed: Jun. 9, 2020
(86) PCT No.: PCT/IB2020/055396

§ 371 Date: Dec. 6, 2021

(30) Foreign Application Priority Data
Jun. 12, 2019 (FR) 19/06228

(51) Int. Cl. A01K 63/10

(52) U.S. Cl. CPC A01K 63/10

(57) ABSTRACT

Device for treating internal walls of aquatic basins includes at least one suction cup head, a mobility assembly by means of which it is possible to move the suction cup head along a wall that is to be treated, the mobility assembly including a traveler having motorized wheels that can be oriented according to two unique rolling positions, these two positions being at 90 degrees to one another.

### CROSS-REFERENCE TO RELATED APPLICATION(S)

This is a National Stage Entry into the United States Patent and Trademark Office from International Patent Application No. PCT/IB2020/055396, filed on Jun. 9, 2020, which relies on and claims priority to French Patent Application No. FR 19/06228, filed on Jun. 12, 2019, the entire contents of both of which are incorporated herein by reference.

### FIELD OF THE INVENTION

The present invention relates to a system for treating walls of aquatic tanks. It relates more particularly to a system for treating internal walls of aquatic tanks, having at least one working head and a mobility assembly for moving the working head along a wall to be treated.

### DESCRIPTION OF THE RELATED ART

Aquatic tanks such as aquariums are intended to be viewed by the public and therefore have to have clean walls with a high quality of transparency. The transparent surfaces of the aquatic tanks therefore need to be cleaned regularly. The majority of tanks have several varieties of fish and marine plants, which are often a source of various kinds of dirt and cause the deposition of biofilms along the walls of the tank. The biofilms can easily impede the visibility of an aquarium after just a few days. Cleaning work on the walls therefore needs to be repeated at regular intervals in order to prevent the biofilm from becoming too thick and difficult to remove.

Various prior art processes are used to clean the transparent surfaces of aquariums. Often, the known processes require not only intrusive means that are detrimental to the life forms present in the aquatic tanks but also laborious human intervention that is not easy to implement.

Generally, the cleaning of transparent surfaces of aquatic tanks is carried out by hand. Large tanks are often cleaned by operators positioned on available surfaces above the tank. They use poles provided with brushes or sponges to rub the walls. The movements carried out are irregular and certain areas can be forgotten. The quality of cleaning is often approximate on account of the application of a non-constant rubbing force and a random number of passes.

Other cleaning methods are also known. For example, systems having an element inside the tank and an element outside the tank are known, the two elements cooperating with one another by virtue of a magnetic effect. An operator, positioned outside the tank, can then move the outside element, thereby entraining the inside element.

For example, the patent application EP2012581 proposes a device for cleaning aquarium panes, and notably the insides of aquarium panes. That device has an element that can be positioned on an internal wall of the aquarium pane. The device also comprises an external element that is positioned on the external face of the wall. The internal and external elements of the device are respectively attracted by the magnetic force such that the internal element of the device follows the movements of the external element. A cleaning surface is installed within the device. This surface is turned directly against the internal wall of the aquarium. That device makes it easier to clean walls of small dimensions. For large walls, which are often high, the operator is forced to use various means to be able to cover the entire surface.

The document EP1947932 also relates to an aquarium cleaning device that has an internal component that comprises a plate used as cleaning surface, and an alternatively operative cleaning component situated on an opposite surface to the surface to be cleaned. A magnetic element is positioned on the plate and a buoyancy means is located at one end of the plate. An exterior component has a body that is fixed to the exterior surface of a wall of the aquarium. A second magnetic element is carried by the body, such that the body can be positioned between the two magnetic elements with the cleaning surface adjacent to the aquarium wall. By moving the body between the first and second positions, the internal component is moved inside the aquarium in order to clean the various surfaces.

Likewise, the application WO2008006259 describes a magnetic cleaner for cleaning aquarium panes, comprising an interior cleaning element intended to slide over the interior surface of the pane. This interior cleaning element comprises a front cover, a rear cover, a magnet, and a cleaning surface. The device also comprises an exterior cleaning element positioned on the exterior surface of the pane. The magnetic force between the interior and exterior cleaning elements makes it possible to drive the movement of the interior cleaning element by moving the exterior cleaning element.

The application EP1738642 relates to a device for cleaning the internal surface of an aquarium, having an interior body. The interior body has a cleaning surface made of foam, which is intended to be in contact with the wall to be cleaned. The interior body is moved over the magnetic surface by virtue of the magnetic force linking it to an exterior component.

The document WO2007127472 also forms another example of treatment and proposes a remote surface preparation mechanism, such that the cleaning of the interior surface of an aquarium is managed from the outside. The cleaning device comprises a body provided with at least one magnetic element that is coupled, for remote control, to complementary magnetic elements, in a movable drive head located at a distance.

Finally, the document WO0040080 describes a device for cleaning aquarium panes, in particular the inside of aquarium panes. The device comprises an interior element positioned on the interior wall of the pane, and an exterior element positioned on the exterior side of the aquarium pane. These interior and exterior elements are attracted toward one another under the effect of a magnetic force, such that the movement of the exterior element along the aquarium pane causes the same movement of the interior element. The device is characterized in that the element positioned inside the aquarium is designed to float on the liquid medium contained in the aquarium when the magnetic force is no longer applied.

The prior art, as illustrated by the documents cited above, proposes systems for polishing and/or cleaning surfaces of aquariums by virtue of different magnetic mechanisms. Such processes have a number of drawbacks, however. The magnetic force necessary for surface treatment makes it necessary to install two elements on either side of the wall of the aquatic tank to be treated. This system also makes it necessary to have easy access from the outside regardless of the arrangement of the walls to be cleaned, this not always being the case in practice. The treatment technique, in particular using magnetic mechanisms, is very often limited to relatively thin walls, thereby excluding the treatment of large aquatic tanks, the walls of which can have a thickness of several tens of centimeters. Likewise, the magnetic element fixed to the internal wall of the aquatic tank is set in motion by the setting in motion of the external element, often by human intervention, this ruling out the automation of the process. These different systems do not make it possible to adjust or vary the intensity of the force applied to the cleaning face. Finally, the cleaning face inside the tank is rapidly saturated with dirt and biofilm, considerably reducing the quality of cleaning.

Treatment systems provided with movement means entirely inside the tank are also known, for example the one in the application FR3067563, which describes a system for treating walls of aquatic tanks, comprising a treatment head provided with a containment chamber provided with an opening that is able to be oriented toward the wall to be treated, said treatment head being movable on a support with the aid of a treatment movement motor for allowing the treatment of said wall, the support consisting of a repositionable movable support that is capable of being fixed to the wall to be treated by suction cups and comprises a movement rail for treatment on which the treatment head can move, a translation rail making it possible to move the movable support in translation when the treatment head is idle and fixed to the surface in the movable-support repositioning mode.

The document FR3033229 describes a system for treating internal walls of aquatic tanks by polishing, having an abrasive mixture reservoir and a surface treatment head in fluidic communication with the abrasive mixture reservoir, rails for moving the treatment head along the wall to be treated, and means for supplying the treatment head with abrasive mixture in a substantially continuous flow.

These two last systems make it possible to ensure reliable and precise guidance without any risk of deviating from the intended path, but require a heavy, bulky and expensive installation. Moreover, the large size of the rails makes these systems incompatible with tanks that are difficult to access.

The document FR2557059 describes a vehicle having suction cups that is able to move around on vertical surfaces. The suction cups are arranged so as to form crawlers disposed on each side of the vehicle. The suction cups of that vehicle are used as a carriage for the purposes of movement.

The document FR2010190 describes a multifunctional device that is able to move along a wall. According to one particular embodiment, the device is designed to clean swimming pool walls. The working head forms a single large suction cup. Wheels are arranged at the edges of the working head for movement purposes. The carriage is therefore incorporated into the single suction head.

The document U.S. Pat. No. 3,337,889 relates to a device for cleaning the internal walls of large tanks such as aquariums. The working head forms a single large suction cup. Wheels are arranged at the edges of the working head for movement purposes. The carriage is therefore incorporated into the single suction head.

### SUMMARY OF THE INVENTION

To remedy these various drawbacks, the invention provides various technical means.

First of all, a first objective of the invention consists in providing a treatment system, in particular for cleaning walls of aquatic tanks, which is simple, inexpensive and easy to employ.

Another objective of the invention consists in providing a treatment system, in particular for cleaning walls of aquatic tanks, which allows precise and strict monitoring of the path followed along the wall to be treated.

Lastly, another objective of the invention consists in providing a treatment system, in particular for cleaning walls of aquatic tanks, which makes it possible to avoid leaving untreated areas.

To this end, the invention provides a device for treating internal walls of aquatic tanks, having at least two suction heads connected together by a framework and a mobility assembly for moving the treatment device along a wall to be treated, said mobility assembly having a motor-driven carriage with wheels, rollers or crawlers, said carriage being able to be activated or oriented in two unique running positions that are angularly spaced apart from one another by 90 degrees, wherein the carriage is independent of the suction heads, connected to the framework and positioned at the center of the latter.

Such a device, which is movable only in two mutually perpendicular positions, namely along an X axis or a Y axis, makes it possible to ensure movement along the wall to be treated, making it easier to carry out a treatment without leaving an area or surface untreated. Specifically, the movements only along the X and Y axis make it possible to easily maintain a reliable reference, for example relative to the starting position. Counting the wheel revolutions or revolutions of other means makes it possible to be well aware of the position of the device. These tracking elements can make it possible to implement simple and reliable automated movement of the device.

The suction heads and the carriage are independent, that is to say separate from one another, and each have a specific function, namely suction and possible wall treatment in the case of the suction heads and movement of the treatment device in the case of the carriage. Furthermore, the central location of the carriage ensures stability and a dynamic equilibrium. Such an architecture with a plurality of suction heads makes it possible to considerably increase the working potential. The single carriage, arranged centrally, provides a simple, effective and inexpensive architecture, without a source of disruption for the tank.

According to one advantageous embodiment, the carriage is connected to the framework by a carriage support.

According to one advantageous embodiment, the carriage has at least two wheels, rollers or crawlers separated axially by at least one sealed motor connected to these wheels. This simple architecture makes it possible to install an effective driving means.

According to another advantageous embodiment, the carriage has an angular actuator designed to allow the carriage to be oriented with respect to the treatment device in two unique operating positions, one oriented along an X axis, the other oriented along a Y axis.

Advantageously, the carriage has one or two motor-driven axles, connected to the wheels, the angular actuator being disposed between the motor-driven axle(s).

Likewise advantageously, the angular actuator comprises a rotary actuator shaft oriented perpendicularly to the plane formed by the wheels of the carriage. The actuator disposed in this way makes it possible to control the orientation of the wheels of the carriage in a simple and reliable manner.

According to one advantageous embodiment, the angular actuator is controlled by a remote control having a selector for movement along the X or Y axis. Such a remote control allows an operator for example to manage the movement of the device during a treatment phase. The remote control advantageously has other control elements, in particular for managing the operation of the working heads, and/or for managing the level of grip or slip of the suction cups on the wall.

According to one advantageous embodiment, the framework forms a peripheral frame in the form of a quadrilateral or triangle, the suction heads being disposed at the corners of the frame.

In a variant, the framework forms a straight line, the suction heads being disposed at the ends of the straight line.

According to another advantageous embodiment, the suction head comprises a rotary disk that is designed to rotate and is connected to a rotary shaft capable of being driven by a disk motor, the rotary disk bearing a wall interface layer comprising a plurality of radial grooves connecting the rotational center of the disk to the periphery of the disk and at least one orifice that ensures, when in operation in an aquatic tank in the immediate vicinity of a wall to be treated, a flow of water between the rear of the disk and the radial grooves arranged in the portion of the disk that is situated next to the wall to be treated.

The system makes it possible to clean and eliminate the biofilm present on the submerged walls of aquariums or any aquatic tank wall. When the rotary disk is driven in rotation, and it is located at a small distance from the wall to be treated, suction is effected, causing the head to be pressed against the wall. Circulation of water is realized. The water circulates in the grooves of the working disk and is ejected laterally and then released into the water of the tank. Thus, the water circulates in the rubbing foam of the disk, rinsing it and carrying away the biofilm and other dirt removed from the wall. Furthermore, the faster the working disk rotates, the higher the suction and the greater the rubbing of the wall are. Such an arrangement thus makes it possible to place and hold a working head against a wall to be treated without an operator or without the aid of a thrust propeller positioned on the opposite side from the disk. The hydrodynamic effect brought about by the rotation of the grooves makes it possible to realize a suction function. Such an arrangement makes it possible to treat walls with a large area in an automatic or semi-automatic manner without human intervention in the tank.

Advantageously, the working disk comprises at least one orifice, provided in the central region of said disk. These orifices make it possible to ensure fluidic circulation from the water of the tank to the rubbing foam and more particularly the radial grooves. The circulation of water makes it possible to sustain the cleaning action of the foam by virtue of a self-cleaning effect of the latter.

According to one embodiment, the orifice(s) are disposed at the perimeter of the rotary shaft. In a variant, the rotary shaft has a through-orifice.

Advantageously, the dynamic suction head comprises an axial peripheral sleeve. The axial peripheral sleeve advantageously has a circumferential side wall arranged so as to surround the working disk. In this way, the peripheral sleeve makes it possible to confine the action of the rotary foam while minimizing hydrodynamic disturbances, for example in order that sand or impurities in the vicinity of the wall are not driven into the foam.

According to one advantageous embodiment, the interface layer has a treatment surface and the dynamic suction head serves both to fix the treatment device to a tank wall to be treated and to carry out a cleaning or polishing treatment on the wall with the aid of said treatment surface.

An advantageous variant provides for an evacuation hole to be arranged through the side wall of the axial peripheral sleeve. This hole allows the flow of water to circulate toward the exterior of the peripheral sleeve, driving the impurities and dirt to the exterior of the sleeve.

Advantageously, the working disk cooperates with the axial peripheral sleeve via at least one spring. The peripheral sleeve is thus movable axially with respect to the working disk. The axially sliding peripheral sleeve, which is held against the wall to be treated by one or more springs, makes it possible to decouple the load exerted by the peripheral sleeve from that exerted by the working disk. For example, a spring with a low stiffness characteristic is provided in order that the peripheral sleeve applies moderate pressure to the wall. A moderate pressure means a bearing force that makes it possible to hold the peripheral sleeve against the wall, while allowing it and the whole of the working head to slide against the wall, in order to make it possible to clean the entire submerged surface of the wall.

### DESCRIPTION OF THE FIGURES

All the embodiment details are given in the following description, supplemented by FIGS. 1 to 10, which are given only by way of nonlimiting examples and in which:

FIG. 1 is a schematic depiction of an exemplary embodiment of a treatment system, in particular for wall cleaning, using a mobility assembly with a motor-driven carriage;

FIG. 2 is a schematic depiction of an exemplary embodiment of a treatment system, in particular for wall polishing, using a mobility assembly with a motor-driven carriage;

FIG. 3 is a schematic depiction of an exemplary embodiment of a motor-driven carriage in side view;

FIG. 4 is a schematic depiction of an exemplary embodiment of a motor-driven carriage in top view;

FIG. 5 is a schematic depiction of an exemplary embodiment of a treatment system, in particular for wall cleaning, using a mobility assembly with a motor-driven carriage oriented to move along the Y axis;

FIG. 6 is a schematic depiction of an exemplary embodiment of a treatment system, in particular for wall cleaning, using a mobility system with a motor-driven carriage oriented to move along the X axis;

FIG. 7 is a face-on view from the exterior of an aquatic tank of an example of a working disk;

FIG. 8 is a face-on view of an embodiment variant of the working disk in FIG. 7;

FIG. 9 is a schematic depiction of an exemplary embodiment of a treatment head;

FIG. 10 is a schematic depiction of another exemplary embodiment of a treatment head.

### DETAILED DESCRIPTION OF THE INVENTION

### Wall Treatment Device

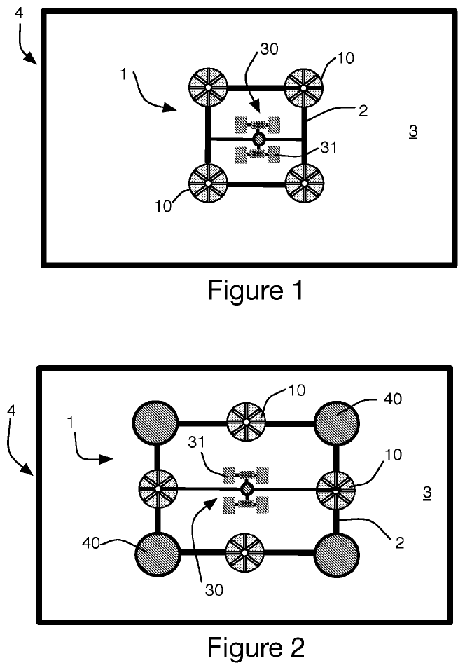

FIG. 1 is a schematic depiction of an exemplary embodiment of a device 1 for treating a wall by cleaning. A set of four dynamic suction heads 10 having a dual function make it possible both to fix the system 1 to a wall 3 to be cleaned and to clean the wall by means of a mechanical non-abrasive rubbing action, for example with the aid of a wall interface layer 14 which is specifically designed to carry out this cleaning function, as described below with reference to FIGS. 6 to 9. In the example illustrated, the dynamic heads 10 are provided at the four corners of the treatment system in order to make it easier to access the edges and corners of the walls 3 to be treated. The suction heads 10 are connected together by a framework 2, in this example in the form of an assembly of tubes in the form of a square or rectangle. The framework 2 forms a peripheral frame in the form of a quadrilateral inside which a carriage (described below) is arranged centrally. Other types of configuration can be provided.

### Carriage Having Motor-Driven Wheels

In order to move the treatment device, a carriage 30 comprises one or more wheels 31 or rollers or crawlers disposed so as to be in contact with the wall 3 to be treated so as to roll over the latter.

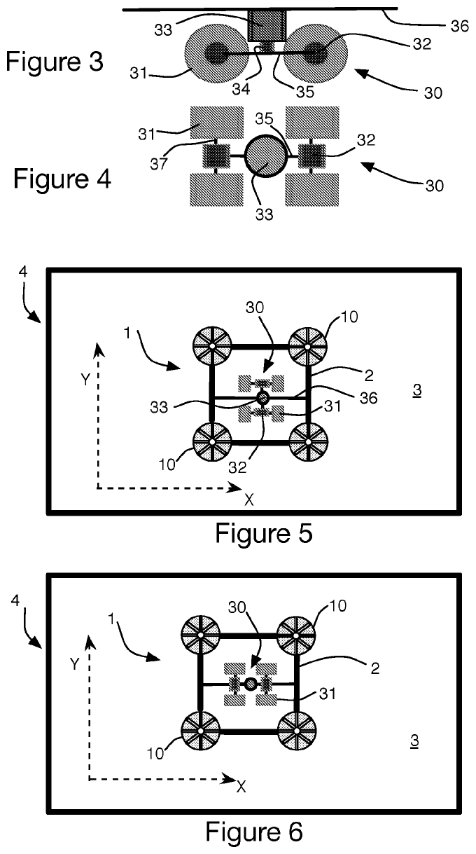

For the sake of simplicity, FIGS. 1 to 6 illustrate only exemplary embodiments in which the carriage has wheels or rollers 31. In these different examples, the wheels or rollers may be replaced by crawlers.

When the carriage 30 has a single wheel or roller, the latter can pivot through 90° at the center of the treatment device 1 by virtue of an angular actuator, and it is driven by a sealed motor.

When the carriage 30 has a plurality of wheels or rollers, two of its parallel sides each have a sealed drive capable of driving all the wheels on one and the same side. When the carriage 30 has crawlers, two of its parallel sides each have a sealed drive capable of driving the crawler on one and the same side. All of these examples are preferably remote controlled for example with the aid of a suitable remote control.

The action of the wheels, rollers or crawlers against the wall makes it possible to move the treatment device. The suction power of the dynamic suction heads is regulated and adapted so as to allow both a fixing force against this wall and sufficient rubbing of the interface layer 14 to clean the wall, while allowing the movement along the latter through the action of the wheels, rollers, crawlers. The value of this adapted suction force can be obtained through the assistance and the action of one or more calibrated springs advantageously arranged between the framework 2 of the treatment device and the carriage 30 having wheels, crawlers or rollers, and thus allow the latter to grip the wall 3 optimally.

A carriage support 36, in this example a rod, makes it possible to connect the carriage 30 to the framework 2 of the treatment device. For more stability and a good dynamic equilibrium, the carriage 30 is arranged at the center of the framework 2. The drives and the disks of the suction heads are preferably provided to rotate in opposite directions in order to compensate for the torque effect that tends to turn a single head in the opposite direction to the actuating motor of the disk.

Various configurations that are not illustrated are likewise provided, for example an architecture with two suction heads separated by a carriage disposed between the heads. The framework 2 then forms a straight line or bar bearing the suction heads at its ends and the carriage 30 in the middle. A triangular arrangement, with three heads and a central carriage, is likewise possible. The peripheral framework is then arranged in the form of a triangle. The suction heads are disposed at the corners of the triangle. The carriage is positioned at the center of the triangular framework, and fixed for example by a carriage support 36.

The carriage 30 bearing wheels, rollers or crawlers can pivot on itself. According to a first configuration, the pivoting is effected, for example: by setting the wheels, rollers or crawlers in rotation simultaneously and at an equivalent speed, but in opposite directions for each side of the carriage. After pivoting, the wheels, rollers or crawlers can be set in rotation simultaneously and at an equivalent speed in the same direction and thus allow the treatment system to be moved in all necessary directions.

A second pivoting configuration uses a rotary actuator 33 connected to all of the wheels, rollers or crawlers by a rotary actuator shaft 34.

In both cases, the axis of rotation of the carriage 30 lies at the center of the framework 2 of the treatment device.

In a variant, the carriage 30 may be fixed with respect to the framework 2: in this case, the wheels, rollers or crawlers can be disposed in the following manner: along the X axis, at least one wheel, roller or crawler each are disposed on two parallel sides, with their sealed drive. Along the Y axis, at least one wheel, roller or crawler each are disposed on two parallel sides opposite to the X axis with their sealed drive. These movement systems comprising motor-driven wheels, rollers or crawlers along the X and Y axis are alternately retractable by virtue of the actuators. This makes it possible to remain in contact with the wall at all times without losing the X or Y reference. During a change of direction, the treatment device 1 is immobilized in order that the part of the carriage comprising wheels, rollers or crawlers that have been retracted is deployed and, once in contact with the wall, the part of the carriage dedicated to the other axis is retracted in turn, and then the rotation of the elements against the wall can resume in the new direction offset by 90°.

Another variant provides at least one motor-driven wheel, roller or crawler that is retractable from the wall on its carriage 30 by virtue of an actuator. The carriage 30 can pivot on itself through 90° by virtue of a rotary actuator. Once the new angular position along the X or Y axis has been reached, at least one motor-driven wheel, roller or crawler each are redeployed and placed in contact with the wall 3. Then, their rotation against the latter allows the treatment device 1 to be moved in another direction along the X or Y axis.

It may also be noted that, regardless of the variant chosen, locking shoes that adhere to the wall 3 can be deployed by the actuators between two suction heads 10 for example in order to improve the stability and the maintenance of the positional reference of the suction heads 10 when the carriage 30 pivots on itself or when the elements thereof are retracted. This example is a nonlimiting option.

The pivotably mounted carriage allows all of the wheels, rollers or crawlers to be oriented in two unique and exclusive reference X and Y directions. By default, movements in any other direction are prevented or blocked. This configuration is illustrated in FIGS. 5 and 6. This configuration ensures good tracking of the path followed and to be followed along the wall to be treated, ensuring that the entire surface is treated. For example, in order to carry out a treatment along a succession of parallel lines, the system moves along the X axis as far as the end of a line, then moves along the Y axis as far as the following line, then resumes moving along the X axis in the opposite direction. The system can thus move over the entire surface to be treated, avoiding any deviation from the path. The fact that tracking is maintained by maintaining the starting reference makes it easier to manage the treatment route, without any untreated areas being left. This configuration also ensures movement in successive parallel columns or a hybrid configuration for example by carrying out successive rectangles. In a variant, the configuration of movement exclusively along the X or Y axis by default can be deactivated, for example for an occasional movement in which there is a desire to head directly for a specific point on a wall, in order to carry out a localized touch-up or the like.

According to another variant, the treatment device 1 has an automated system. This system makes it possible, when a change in direction is ordered via the remote control, to stop the movement of the treatment device 1, then to reposition the carriage 30 along the X or Y axis, then to resume the movement of the treatment device 1 in the desired direction automatically, as soon as the repositioning end-of-travel system is activated. This driving assistance for the treatment device 1 further optimizes its configuration of movement in two unique and exclusive reference X or Y directions mentioned above.

FIG. 2 is a schematic depiction of an exemplary embodiment of a system for treating a wall by polishing. A set of four single-acting dynamic suction heads 10 make it possible to fix the device 1 to the wall 3 to be cleaned. Four working heads 40 designed for polishing tasks are provided at the four corners of the device in order to polish the wall by means of a slightly abrasive mechanical rubbing action of known type.

In the example illustrated, the independent heads 40 are provided at the four corners of the treatment system in order to make it easier to access the edges and corners of the walls 3 to be treated. Other types of configuration can be provided. The movement of the system along the wall to be treated is ensured by a carriage 30 having motor-driven wheels as described above.

### Rotary Disk And Suction Effect

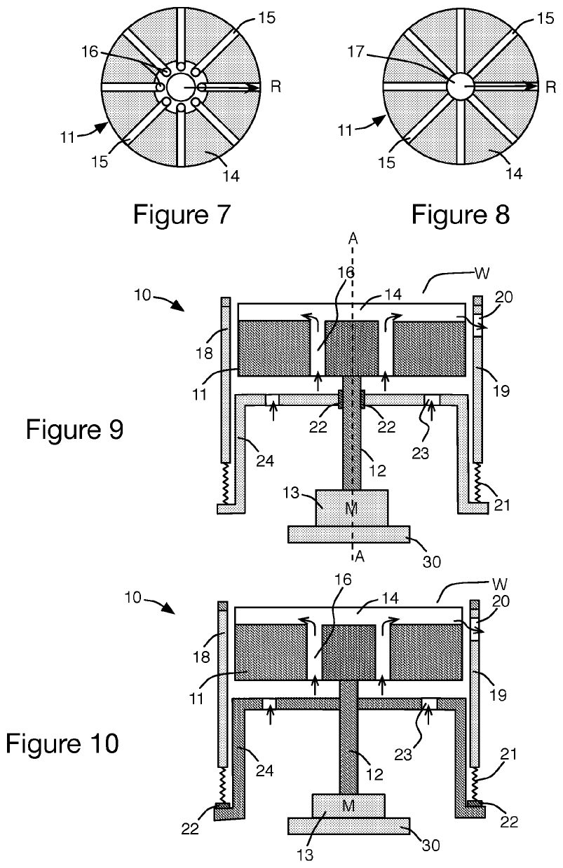

FIGS. 7 and 8 illustrate exemplary embodiments of rotary disks 11 as seen from the face that is able to be in contact with the wall of the tank 4 to be treated. It is apparent that the disk 11, of radius R, comprises a plurality of radial grooves 15 or slots, i.e. ones that are oriented in the direction of the radius R. The grooves are oriented radially from the rotational center of the disk. In the exemplary embodiment in FIG. 7, a plurality of orifices 16 are arranged around the rotary shaft. Each of these orifices 16 communicates with a groove 15. In the exemplary embodiment in FIG. 8, a single orifice 17 is arranged centrally in the rotary shaft 12 connecting the disk 11 to a motor 13 that is visible in FIGS. 9 and 10. The central orifice 17 communicates with each of the grooves 15. On account of this or these orifice(s) 16 or 17 and the grooves 15, when the disk is set in rotation in the immediate vicinity of a wall to be treated in an aquatic environment, a flow of water is generated between the rear and the front of the disk, i.e. from the rear of the disk 11, then through the disk and passing along the grooves 15 arranged radially in the portion of the disk situated next to the wall. This hydrodynamic flow generates a suction effect that tends to press the disk against the wall to be treated. The level of the suction effect is variable depending on the number and the dimensions of the grooves, on the diameter of the disk, on the material used, and especially on the speed of rotation of the disk. This suction effect allows the disks to fulfill various hydromechanical functions, as explained below.

### Single- or Dual-Function Suction Head

FIGS. 9 and 10 illustrate, in cross section, examples of a dynamic suction head 10 bearing a disk such as the one illustrated in FIG. 7 or 8. As illustrated, the disk 11 has a wall interface layer 14 on the side of the disk intended to interface, with or without contact, with the wall 3 to be treated. The interface layer 14 is either separate from the disk 11 or integral with or in one piece with the disk. The disk 11 is made of a rigid and preferably nonporous material, for example aluminum. The grooves 15 and the orifices 16 and 17 are advantageously made in the mass of the disk 11.

Depending on the embodiments, the dynamic suction head implements one or two functions. Specifically, it can generate a suction function as described above. It can also generate a suction effect coupled with a wall treatment effect, for example a cleaning or polishing effect (dual mode).

In the case of the dual mode, the interface layer 14 comprises a treatment surface made of a material that makes it possible to carry out cleaning work on a wall of an aquatic tank 4, often made of PMMA, without otherwise risking damaging said wall. The treatment surface may be made for example: of polyurethane or of polyethylene with variable hardnesses and densities and (open or closed) cell dimensions and porosities that are variable depending on the objectives of the treatment.

In the case of the dual mode, a variant can provide an interface layer made up of more or less flexible lips disposed in the continuation of the walls of the grooves 15 and made directly from the mass of the disk 11 or from that of the interface layer 14. What is being referred to in this case are walls of the grooves 15 perpendicular to the wall to be treated 3. These lips protrude by several millimeters from the surface of the disk 11 or from the interface layer 14. They can have a length more or less equal to the radius R of the disk 11 and may be single or double.

Specifically, the presence of these lips, positioned in the grooves 15, favors the flow of water in the latter in order to evacuate the biofilm scraped off the wall during the rotation of the disk 11.

Thus, in this dual-function mode, the interface layer 14 is in contact with the wall to be treated.

In the case of the single-function mode with a simple holding effect, the disk 11 is located preferably at a small distance from the wall, for example a few millimeters therefrom, in order to ensure the hydrodynamic effect, while avoiding contact with the wall.

A motor 13 and a shaft 12 oriented along the axis A-A, which are provided in the suction head, allow the rotary disk 11 to be set in rotation. When the disk is submerged and situated at a small distance (for example 1 to 2 cm for a disk with a diameter of 100 mm) from a wall to be treated, the rotation of the grooved disk produces a negative pressure that tends to move the working disk toward the wall 3, the latter being fixed. The suction head 10 is designed to be able to move toward the wall by virtue of this effect. In the case of a disk with a diameter as mentioned above, the speed of rotation that makes it possible to produce the hydrodynamic effect that tends to press the disk against the wall to be treated is for example between 800 and 1200 rpm (purely by way of example).

The arrows in FIGS. 9 and 10 illustrate an example of water flow when a suction head is in position against a wall of an aquatic tank 4. The water comes from the rear of the working disk, passes through the orifices 16 and 17 and then communicates with the radial grooves 15. Once the disk is in position, the flow of water takes place continuously as long as the rotation of the disk is maintained. In addition to contributing to the suction effect, this flow makes it possible to ensure that the treatment surface is cleaned in order to prevent the biofilm and other dirt removed during the cleaning of the wall from collecting on the disk and saturating the treatment surface, preventing the cleaning treatment from being continued. In this dual-function embodiment, the suction disk is in direct contact with the wall to be treated. It acts on the latter by rubbing in order to carry out a cleaning action.

The suction head 10 preferably comprises a peripheral sleeve 18 arranged coaxially with the rotary shaft 12. This sleeve has a circumferential side wall 19 designed to surround the rotary disk 11. In the examples in FIGS. 9 and 10, the sleeve continues toward the rear of the rotary disks so as to surround a portion of the shaft 12. The sleeve makes it possible to delimit a working zone W inside which the disk carries out a cleaning action against the wall to be treated. This working zone W is also delimited at the rear of the disk 11 by a cover 24, closing the sleeve 18. In the examples illustrated, the cover 24 is in the form of an inverted U, with a central opening for the shaft 12 of the motor to pass through. Complementary orifices 23 provided in the cover 24 ensure fluidic communication between the working zone W and the zone of the motor M. The cover 24 may also be flat or in the form of a non-inverted U.

An evacuation hole 20 is arranged through the side wall 19 of the axial peripheral sleeve 18. This tunnel allows the flow of water to leave the sleeve to return to the tank. The tunnel is advantageously positioned so as to be located in the upper zone of the suction head 10 during cleaning phases. This prevents the exiting flow of water from acting against the bottom of the tank, which would risk pushing stones or particles or dirt toward the working head. If a hard and/or abrasive foreign body were ever to be located between the working disk and the wall to be treated, there would be significant risks of the wall being scratched or damaged in some other way. The peripheral sleeve 18 provides additional protection against the ingress of such contaminants into the working zone W. A filtration element or system can be connected to this evacuation hole 20.

In order to prevent the peripheral sleeve 18 from exerting an excessive force on the wall 3, one embodiment provides for the rotary disk 11 to cooperate with this sleeve via at least one spring 21. Use is made for example of a peripheral spring arranged axially in the continuation of the opposite end of the peripheral sleeve 18 from the working zone W. The spring 21 acts on the sleeve 18 on one side and on the cover 24 on the other.

In contrast to the assembly formed by the disk 11 and the interface layer, the peripheral sleeve 18 is designed to remain angularly fixed, without rotation, with respect to the wall to be treated. A circumferential seal or a material with a hardness less than the wall to be treated is advantageously provided at the contact end of the peripheral sleeve 18. This seal or material allows gentle contact with the wall, without risking damaging it. The connection between the angularly fixed part of the head and the rotary part of the head is provided by a bearing 22, for example a plain bearing or rolling bearing. FIGS. 9 and 10 illustrate two embodiments of a suction head 10. In the embodiment in FIG. 10, the parts that can be set in rotation comprise the shaft 12, the disk 11, the interface layer 14 and the cover 24. The bearing 22 is arranged between the cover and the spring 21. In the embodiment in FIG. 9, the parts that can be set in rotation comprise only the shaft 12, the disk 11 and the interface layer 14. In this case, the bearing 22 is arranged between the shaft 12 and the cover 24.

1. A device for treating internal walls of aquatic tanks, having at least two suction heads connected together by a framework and a mobility assembly for moving the treatment device along a wall to be treated, said mobility assembly having a motor-driven carriage with wheels, rollers or crawlers, said carriage being able to be activated or oriented in two unique running positions that are angularly spaced apart from one another by 90 degrees, wherein the carriage is independent of the suction heads, connected to the framework and positioned at the center of the latter.

2. The treatment device as claimed in claim 1, wherein the carriage is connected to the framework by a carriage support.

3. The treatment device as claimed in claim 1, wherein the carriage has at least two wheels, rollers or crawlers separated axially by at least one sealed motor connected to these wheels, rollers or crawlers.

4. The treatment device as claimed in claim 1, wherein the carriage has an angular actuator designed to allow the carriage to be oriented with respect to the treatment device in two unique operating positions, one oriented along an X axis, the other oriented along a Y axis.

5. The treatment device as claimed in claim 4, wherein the carriage has one or two motor-driven axles, connected to the wheels, rollers or crawlers, the angular actuator being disposed between the motor-driven axle(s).

6. The treatment device as claimed in claim 4, wherein the angular actuator comprises a rotary actuator shaft oriented perpendicularly to the plane formed by the wheels, rollers or crawlers of the carriage.

7. The treatment device as claimed in claim 1, wherein the framework forms a peripheral frame in the form of a quadrilateral or triangle, the suction heads being disposed at the corners of the frame.

8. The treatment device as claimed in claim 1, wherein the framework forms a straight line, the suction heads being disposed at the ends of the straight line.

9. The treatment device as claimed in claim 1, wherein the suction head comprises a rotary disk that is designed to rotate and is connected to a rotary shaft capable of being driven by a disk motor, the rotary disk bearing a wall interface layer comprising a plurality of radial grooves connecting the rotational center of the disk to the periphery of the disk and at least one orifice that ensures, when in operation in an aquatic tank in the immediate vicinity of a wall to be treated, a flow of water between the rear of the disk and the radial grooves arranged in the portion of the disk that is situated next to the wall to be treated.

10. The treatment device as claimed in claim 9, wherein the suction head comprises an axial peripheral sleeve.

11. The treatment device as claimed in claim 9, wherein the interface layer has a treatment surface and the suction head serves both to fix the treatment device to a tank wall to be treated and to carry out a cleaning or polishing treatment on the wall with the aid of said treatment surface.
